(19) United States
(12) Patent Application Publication
(10) Pub. No.: US 2026/0264514 A1
(43) Pub. Date: Sep. 10, 2026

(54) METHOD FOR CONTROLLING A DRIVE DEVICE FOR A WORKING MACHINE

(71) Applicant: ZF Friedrichshafen AG, Friedrichshafen (DE)

(72) Inventors: Nikolai EGLER, Riedhausen (DE); Joachim SAUTER, Berg (DE); Markus RIESTER, Wald (DE); Dieter BALZ, Wangen im Allgäu (DE); Raphael GONZALEZ, Leutkirch (DE)

(73) Assignee: ZF Friedrichshafen AG, Friedrichshafen (DE)

(21) Appl. No.: 19/557,916

(22) Filed: Mar. 5, 2026

(30) Foreign Application Priority Data
Mar. 6, 2025 (DE) 10 2025 108 536.6

(51) Int. Cl. B60K 23/08

(52) U.S. Cl. CPC B60K 23/0808; B60K 2023/0841; B60K 2023/0858

(57) ABSTRACT

A method is provided for controlling a drive device of a working machine having a motor (11), at least one at least partially lockable transverse differential (31, 32, 33), and a sensor setup. The sensor setup is configured to detect operating parameters, including a rotation speed of the output elements of the at least one transverse differential (31, 32, 33). The method includes locking (I) the transverse differential (31, 32, 33) if a locking condition has been met, determining (II) a rotation speed difference (dn) of the output elements of the at least partially locked transverse differential (31, 32, 33), and unlocking (III) the transverse differential (31, 32, 33) if an unlocking condition has been met, which is at least met if the rotation speed difference (dn) in an at least partially locked condition of the transverse differential (31, 32, 33) reaches or exceeds an unlocking threshold value (y1).

### RELATED APPLICATIONS

This application claims the benefit of and right of priority under 35 U.S.C. § 119 to German Patent Application no. 10 2025 108 536.6, filed on 6 Mar. 2025, the contents of which are incorporated herein by reference in its entirety.

### TECHNICAL FIELD

The present invention relates to a method for controlling a drive device for a working machine, to a control unit for carrying out a method for controlling a drive device, to a drive device with a control unit, and to a working machine with a drive device.

### BACKGROUND

Methods for the control of a working machine are known. With the increasing complexity of working machines and the demands for high performance in working machines, there is a need for methods with which a working machine can be operated efficiently, reliably and economically.

### SUMMARY

It is a purpose of the present invention to provide a better method for controlling a drive device, which enables reliable operation of the working machine.

The objective is achieved by a method for controlling a drive device of a working machine. Advantageous further developments will be apparent in light of the present disclosure.

In a first aspect, a method for controlling a drive device for a working machine is proposed. The working machine can be in the form of a loader, a tipper or a dump truck, for example an articulated dump truck. The working machine has a motor, at least one at least partially lockable transverse differential and a sensor setup. The motor is designed to deliver a drive power. The transverse differential is designed to divide the drive power from an input element between two output elements. The sensor setup is designed to detect a number of operating parameters, including a rotation speed of the output elements, for example each of the output elements of the at least one transverse differential. The operating parameters are appropriate for determining whether a locking condition for the transverse differential has been met.

The working machine can comprise a working device. The working device can be designed to carry out a work task such as lifting and/or transporting a load. The working device can be designed as a loading surface, for example a tipper body. The motor can be in the form of an electric motor or an internal combustion engine such as a diesel engine. The motor can comprise a driveshaft. Besides the at least one lockable transverse differential the working machine can comprise a longitudinal differential. The driveshaft can be mechanically functionally connected to an input element of a longitudinal differential in order to input a drive power.

At least one of the longitudinal differential and the transverse differentials can be in the form of a bevel-gear differential or a planetary differential. The longitudinal differential can be in the form of a planetary differential. The transverse differentials can be in the form of bevel-gear differentials. Each one of the longitudinal and the transverse differentials can have one input element and two output elements. One output element of the longitudinal differential can be mechanically functionally connected to an input element of one of the transverse differentials. The other output element of the longitudinal differential can be mechanically functionally connected to an input element of another one of the transverse differentials. In each case one of the output elements of the longitudinal differential can be mechanically functionally connected to the input element of one of the transverse differentials by way of either a cardan shaft or a gear system, for example a spur gear system. Each of the output elements of the transverse differentials can be mechanically functionally connected, for example in a rotationally fixed manner or via a portal gear, to a traction element of the working machine.

When two elements are mechanically functionally connected, they are directly or indirectly coupled to one another in such manner that a movement of one element brings about a reaction by the other element. For example, a mechanical functional connection can be formed by an interlocking or a frictional connection. The mechanical functional connection can correspond to the meshing of teeth of the two elements. Between the two elements further elements such as one or more spur gear stages can be provided. In contrast, a permanent rotationally fixed connection of two elements is understood to be a connection by means of which the two elements are connected solidly to one another under all normal circumstances of the transmission. In that case the elements can be individual components connected rotationally fixed to one another, or they can be made integrally. By means of a shifting element, for example a clutch or brake, a rotationally fixed connection between two elements can be selectively formed or released.

In each case, one of the transverse differentials can be associated with a respective drivable axle unit, for example a drivable front axle or a drivable rear axle. In each case, one of the axle units can comprise one of the transverse differentials. In each case, one of the axle units can comprise two traction elements. The working machine can have, for example, three axle units. An axle unit can be in the form of a drivable front axle. An axle unit can be in the form of a first drivable rear axle. An axle unit can be in the form of a second drivable rear axle. An output element of the longitudinal differential can be mechanically functionally connected to the input element of the transverse differential of the first drivable rear axle. The first drivable rear axle can be designed as a through-drive axle. The through-drive axle can have a through-drive output element. The through-drive output element can be mechanically functionally connected to the input element of the transverse differential of the second rear axle, for example directly and without a longitudinal differential. The through-drive output element can be mechanically functionally connected via a further longitudinal differential to the input element of the transverse differential of the second rear axle.

The drive device can comprise a transmission. The transmission can be a continuously variable transmission. The transmission can provide at least one gear ratio for forward driving and a gear ratio for driving in reverse. The transmission can include the longitudinal differential. The transmission and the longitudinal differential can be accommodated together in a common housing, for example a transmission housing.

The longitudinal differential and the transverse differentials can be lockable, for example lockable by means of a shifting element. The drive device can comprise one shifting element for each differential. The shifting element can be in the form of a clutch, such as a disk clutch. The shifting element can be designed to be actuated or shifted by an actuator. The actuator can be a hydraulic or pneumatic actuator. By means of the actuator a locking pressure can be applied to the shifting element. By virtue of the locking pressure, for example by increasing the locking pressure, the shifting element can be designed to be closed. By closing the shifting element the differential concerned can be lockable, for example completely, at least partially and/or continuously variably. The longitudinal differential and the transverse differentials can be designed to be lockable continuously variably. In that case, when there is a particular stress level between the output elements of the differential, the differential or its shifting element may be damaged, for example the disk clutch thereof. Locking of at least one of the longitudinal differential and the transverse differential can be initiated smoothly, for example by applying a holding pressure.

Each of the transverse differentials can be designed, in its open condition, to equalize the rotation speeds of the traction elements of the drive axle concerned. Each of the transverse differentials can be designed, in its locked or at least partially locked condition, to produce a synchronous load distribution or drive power distribution at the two traction elements of the axle unit concerned, for example in order to reduce an undesired slip between the traction elements or wheel-spin of one of the traction elements. This results in better traction of the working machine.

In its open condition the longitudinal differential can be designed to distribute the drive power to the transverse differentials, for example to distribute it in a load-dependent manner. The longitudinal differential can be designed, in its locked condition, to synchronously distribute the load or the drive power, for example to the two mechanically functionally connected transverse differentials, for example those of the front axle and the first rear axle. This results in better traction of the working machine.

The sensor setup can comprise at least one sensor, for example at least one of a rotation speed sensor, a pressure sensor or an angle sensor. The sensor setup can comprise a rotation speed sensor for each output element of the transverse differentials, for example in order to detect the rotation speeds of each of the output elements of the transverse differentials. The sensor setup can comprise at least four rotation speed sensors, for example two rotation speed sensors for the output elements of the transverse differential of the front axle and two rotation speed sensors for the output elements of the transverse differential of the rear axle. The sensor setup can comprise six rotation speed sensors, for example two additional rotation speed sensors for the output elements of the transverse differential of the second rear axle. The sensor setup can comprise a rotation speed sensor for each traction element, for example to detect the rotation speeds of the traction elements, for example those of the drivable axle units. The sensor setup can comprise a rotation speed sensor for detecting the rotation speed of each output element of the longitudinal differential.

A traction element can be acted upon by longitudinal forces and transverse forces. Longitudinal forces can be produced by acceleration. Transverse forces can be produced, for example, when the working machine is driving round a curve. A resultant force can be formed by superimposing the longitudinal and transverse forces. The resultant force can be directly related to the frictional properties of the ground on which the working machine is standing or moving. If the ground has good frictional properties the longitudinal and transverse forces can have higher values than when the ground has poor frictional properties.

The method entails an at least partial locking of the transverse differential if a locking condition, for example a transverse differential locking condition is met. The method entails determining a rotation speed difference of the output elements of the at least partially locked transverse differential. Alternatively, or in addition, the method can entail determining a rotation speed difference of the traction elements of an at least partially locked axle unit. The method can entail assessing the traction status for the working machine as good if an unlocking condition is met. The unlocking condition is met at least if the rotation speed difference in an at least partially locked condition of the transverse differential reaches or falls below an unlocking threshold value. The method entails unlocking the transverse differential if the unlocking condition is met. In that way, tire wear can be reduced. Overloading of components of the drive device can be reduced or prevented. The maneuverability of the working machine can be improved.

In an embodiment of the method, the at least partially lockable transverse differential can be designed, when the working machine is driving round a curve, to enable a rotation speed difference of the output elements of the at least partially locked transverse differential.

On ground with good frictional properties and, for example, while the working machine is driving round a curve, the traction elements of an axle unit can rotate at different speeds. With an at least partially locked differential, for example a transverse differential, the traction elements and/or output elements can be stressed relative to one another, in particular on ground with good frictional properties and when driving round a curve. A higher degree of stressing can result in damage to the at least partially locked differential, for example a transverse differential or its shifting element or, for example, its disk clutch. The damage may result in slipping of a shifting element in the form of a disk clutch. The damage may bring about a twisting of shafts, for example cardan shafts or driveshafts, by way of which the output elements of one of the transverse differentials is mechanically functionally connected to the traction element concerned. This damage can be detected by the rotation speed sensors, for example by virtue of the rotation speed difference.

If in the at least partially locked condition of the differential, for example the transverse differential, there occurs a rotation speed difference or any distortion between the output elements of one of the differentials or the traction elements of one of the axle units, the traction behavior is assessed as good. Then, the working machine may be on good ground. In that case the differential can be designed to be unlockable. In that way a sudden change of the ground can be recognized. The differential, for example the transverse differential, can be designed to be unlockable if there is any stress. The method can be designed to unlock the transverse differential following the lapse of an assessment interval after the unlocking condition has been met.

In an embodiment of the method, the locking condition can be met if the rotation speed difference reaches or exceeds a locking threshold value.

At least one of the longitudinal differential and the transverse differentials can be designed to be lockable manually or automatically. For manual locking, the locking condition can be met if an operating element such as a button in a vehicle cabin is actuated. A method for the automated unlocking of at least one of the longitudinal differential and the transverse differential can entail determining a rotation speed difference between the rotation speeds of the output elements of one of the respective transverse differentials. The method can entail locking of the longitudinal differential when a longitudinal differential locking condition is met. The longitudinal differential locking condition can be met when one of the rotation speed differences reaches or exceeds a locking threshold value, for example for a longitudinal differential waiting time. The method can entail determining the rotation speed difference for each of the transverse differentials. In that way the method can be designed to recognize at which transverse differential or axle unit undesired slip is taking place. The method can entail determining a rotation speed difference between the rotation speed of an output element of one of the transverse differentials and a rotation speed of an output element of another transverse differential. In that way, the method can be designed to recognize undesired slip at all the traction elements of an axle unit or wheel-spin of a drivable axle. Thereby, individual differentials or all the differentials can be locked, as necessary.

The longitudinal differential locking condition can be met if at least one rotation speed difference of one of the transverse differentials exceeds the locking threshold value. The longitudinal differential locking condition can be met if the rotation speed difference of the output elements of different transverse differentials exceeds the locking threshold value. The locking threshold value can be higher than a rotation speed difference produced between the two output elements of a transverse differential when the working machine drives round a curve, for example during the normal use of the working machine. The locking threshold value can be higher than the unlocking threshold value.

The method can entail locking one of the transverse differentials if a transverse differential locking condition is met. The transverse differential locking condition can be met for the transverse differential whose rotation speed difference meets the longitudinal differential locking condition for a transverse differential waiting time, or for the longitudinal differential waiting time and then the transverse differential waiting time. In that way the longitudinal differential can be locked before the transverse differential is locked.

In an embodiment of the method, the method can also entail determining a rotation speed difference gradient of the rotation speed difference. The unlocking condition can be met if the rotation speed difference gradient reaches or exceeds a gradient unlocking threshold value. If, with an at least partially locked differential, for example a transverse differential, a higher rotation speed difference gradient is determined, the traction behavior can be assessed as good. Then the differential, for example the transverse differential, can be unlocked.

In an embodiment of the method the drive device can comprise a steering mechanism for steering the working machine. The sensor setup can be designed to detect a steering angle of the steering mechanism. In that way it can be recognized when the working machine is driving round a curve. The unlocking threshold value and/or the gradient of the unlocking threshold value can be larger for small steering angles than for large steering angles. With large steering angles, for example when driving round tight curves, the unlocking of the differential, for example the transverse differential, can take place already at a lower rotation speed difference gradient than with small steering angles, for example around long curves. The working machine can have an articulation joint for steering the working machine. By virtue of the articulation joint a front section can be swiveled relative to a rear section, for example by means of a steering hydraulic system or steering pneumatic system. The front section can contain the front axle. The rear section can contain the rear axle. The steering angle can be formed of an articulation angle or a swivel angle of the articulation joint.

In an embodiment of the method, the drive device can comprise a shifting element for locking the transverse differential. The shifting element can be designed to be actuated by a locking pressure. The locking and unlocking can entail adapting the locking pressure. In that way at least one of the locking, for example at least partial locking, and the unlocking of the differential, for example the transverse differential, can be initiated smoothly.

In an embodiment of the method, the locking can entail adapting the locking pressure to a pre-pressure, then reducing the locking pressure to a holding pressure and after that adapting the locking pressure to a target pressure for locking the transverse differential. The locking pressure can be increased to the pre-pressure, for example along a pressure gradient. After the lapse of a holding time the locking pressure can be reduced to the holding pressure, for example along a pressure gradient. After the lapse of the holding time the locking pressure can be increased, for example along a pressure gradient, to the target pressure in order to lock the differential, for example the transverse differential.

In an embodiment of the method, unlocking can entail reducing the locking pressure to an unlocking holding pressure and then reducing the locking pressure farther in order to unlock the transverse differential. The locking pressure can be reduced to the unlocking holding pressure, for example along a pressure gradient. After the lapse of an unlocking holding time the locking pressure can be reduced in order to unlock the differential, for example the transverse differential.

In a second aspect, a control unit is provided in order to carry out the method in accordance with one of the preceding embodiments. Further features, effects, and advantages of the second aspect stem from the first aspect. Furthermore, the features, effects, and advantages of the second aspect correspond to the features, effects and advantages of the first aspect. The control unit can comprise an input interface and an output interface. The input interface can be designed to receive system information, for example at least one operating parameter such as a rotation speed of an output element, a steering angle of the steering mechanism, a locking pressure or the like. The output interface can be designed to control a differential, for example the transverse differential.

In a third aspect, a drive device with a control unit according to the second aspect is provided. Further features, effects, and advantages of the third aspect stem from the preceding aspects. Moreover, features, effects, and advantages of the third aspect correspond to those of the preceding aspects. The drive device comprises a motor, at least one at least partially lockable transverse differential, and a sensor setup. The motor is designed to deliver a drive power. The transverse differential is designed to divide the drive power from an input element between two output elements, for example each of the output elements of the at least one transverse differential. The operating parameters are appropriate for determining whether a locking condition for the transverse differential has been met.

The drive device can comprise a plurality of drivable axle units. The drive device can comprise two drivable axle units, for example a drivable front axle and a drivable rear axle. The drive unit can comprise three axle units, for example an additional, drivable second rear axle. The drive device can comprise at least one longitudinal differential and two transverse differentials. The drive device can comprise one longitudinal differential and three transverse differentials. The drive device can comprise two longitudinal differentials and three transverse differentials. Each one of the longitudinal and transverse differentials can comprise an input element and two output elements. The output elements of the transverse differentials can be designed to be mechanically functionally connected to a traction element, for example by way of at least one of a portal gear and a universal joint shaft. The portal gear can comprise at least one of a spur gear stage and a planetary gearset. The portal gear can be located in the area of a wheel hub. The portal gear can be in the form of a wheel hub gear.

In a fourth aspect, a working machine with a drive device according to any of the preceding embodiments is provided. Further features, effects and advantages of the fourth aspect stem from the preceding aspects. Moreover, features, effects and advantages of the fourth aspect correspond to those of the preceding aspects. The working machine comprises at least two traction elements, each mechanically functionally connected to one of the output elements of the at least one transverse differential in order to propel the working machine. In each case, one of the traction elements can be mechanically functionally connected to an output element of one of the transverse differentials, for example by at least one of a portal gear and a universal joint shaft. A traction element can be in the form of a drive wheel or a chain drive.

### BRIEF DESCRIPTION OF THE FIGURES

FIG. 1 is a view from above, illustrating the principle of an embodiment of a working machine with a drive device.

FIG. 2 is a view from above, illustrating the principle of an embodiment of the working machine on two different kinds of ground with different traction properties.

FIG. 3 illustrates the principle of an embodiment of a method for controlling the drive device.

FIG. 4 is a diagram showing the temporal variation of operating parameters of the working machine while the method is being carried out.

FIG. 5 illustrates the principle of an embodiment of a control unit for carrying out the method.

### DETAILED DESCRIPTION

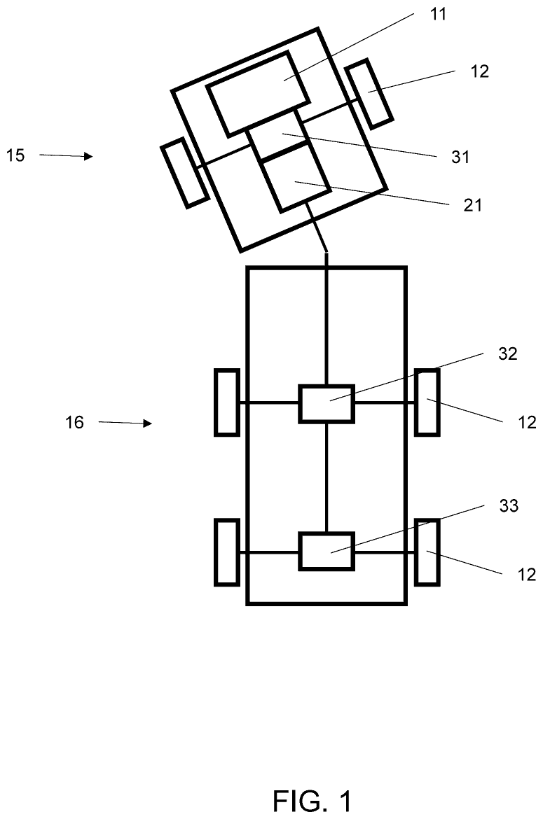

FIG. 1 is a view from above illustrating the principle of an embodiment of a working machine with a drive device. The working machine is in the form of an articulated dump truck. The working machine has a front section 15 and a rear section 16, which are connected to one another by way of an articulation joint to enable steering of the working machine. An articulation angle of the articulation joint forms a steering angle & for the working machine. The rear section 16 has two axle units, in this case a first drivable rear axle and a second drivable rear axle. The front section 15 has one axle unit, in this case a drivable front axle, and a motor 11. The front section 15 has a longitudinal differential 21 with an input element and two output elements. A driveshaft of the motor 11 is mechanically functionally connected to the input element of the longitudinal differential 21 in order to deliver a drive power. The longitudinal differential 21 is designed to divide the drive power between its two output elements.

The drive device comprises three transverse differentials 31, 32, 33, each with an input element and two output elements. Each of the transverse differentials 31, 32, 33 is designed to divide a drive power from its input element between its two output elements. The drivable front axle has a first transverse differential 31. The first drivable rear axle has a second transverse differential 32. The second drivable rear axle has a third transverse differential 33. An output element of the first longitudinal differential 21 is mechanically functionally connected to the input element of the first transverse differential 31. The other output element of the first longitudinal differential 21 is mechanically functionally connected via a universal joint shaft arrangement to the input element of the second transverse differential 32. The first rear axle is in the form of a through-drive axle and has a through-drive output element. The through-drive output element is mechanically functionally connected to an input element of the third transverse differential 33. Each of the output elements of the transverse differentials 31, 32, 33 is mechanically functionally connected with a respective traction element 12.

The drive device comprises a sensor setup. The sensor setup comprises, for each output element of the transverse differentials, a rotation speed sensor in order to detect the rotation speed of the output element concerned. The sensor setup comprises an angle sensor for detecting the steering angle δ. Each of the longitudinal differential and the transverse differentials is designed to be lockable by means of a shifting element. The shifting element is in the form of a disk clutch and can be close continuously variably by a hydraulic actuator.

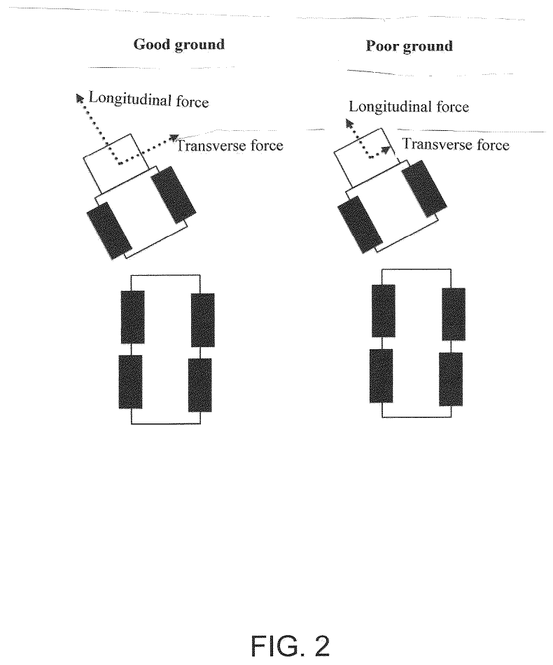

FIG. 2 is a view from above illustrating the principle of an embodiment of the working machine on ground of two different types, with different traction properties. Good ground has a high coefficient of friction. Accordingly, on the good ground, a high longitudinal force and a high transverse force can be transmitted, for example from one of the traction elements 12 to the ground. Poor ground has a low coefficient of friction. The longitudinal and transverse forces that can be transmitted are lower than for the good ground. When the working machine is driving round a curve the traction elements 12 of any one axle unit have different rotation speeds. Thus, when the transverse differentials 31, 32, 33 are at least partially locked, the traction elements 12 are braced relative to one another. The degree of bracing is higher on the good ground than on the poor ground. The high degree of bracing results in breaking free of the transverse differentials 31, 2, 33, for example due to slipping of the shifting elements of the transverse differentials 31, 32, 33 which are in the form of disk clutches. This breaking free can be detected by virtue of the rotation speed sensors. The break-free produces a rotation speed difference dn between the output elements of the transverse differentials 31, 32, 33. On the poor ground, the shifting elements do not break free, but rather, slip takes place relative to the ground at least at one of the traction elements 12.

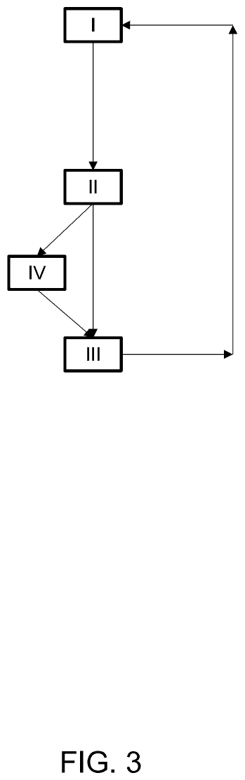

FIG. 3 illustrates the principle of an embodiment of a method for controlling the drive device. In a first step I, the method entails locking the transverse differential 31, 32, 33 if a locking condition is met. The locking condition is met if the rotation speed difference dn reaches or exceeds a locking threshold value x1. In a further step II, the method entails the determination of a rotation speed difference dn of the output elements of the locked differential 31, 32, 33. The traction properties of the working machine are assessed as good if the rotation speed difference dn reaches or exceeds an unlocking threshold value y1, that value being larger for small steering angles δ than for large steering angles δ. Then, an unlocking condition has been met. In a further step IV, the method entails determining a rotation speed difference gradient dn/dt of the rotation speed difference dn. The unlocking condition is met if the rotation speed difference gradient dn/dt reaches or exceeds a gradient unlocking threshold value, which value is larger for small steering angles δ than it is for large steering angles δ. In a further step III, the method entails unlocking the transverse differential 31, 32, 33 when the unlocking condition has been met.

The locking I and the unlocking III entail in each case adapting the locking pressure p. The locking I entails adapting the locking pressure p to a pre-pressure pl, then reducing the locking pressure p to a holding pressure p2 and then adapting the locking pressure p to a target pressure p3 in order to lock the transverse differential 31, 32, 33. The unlocking III entails reducing the locking pressure p to an unlocking holding pressure p4 and then reducing the locking pressure p farther so as to unlock the transverse differential 31, 32, 33.

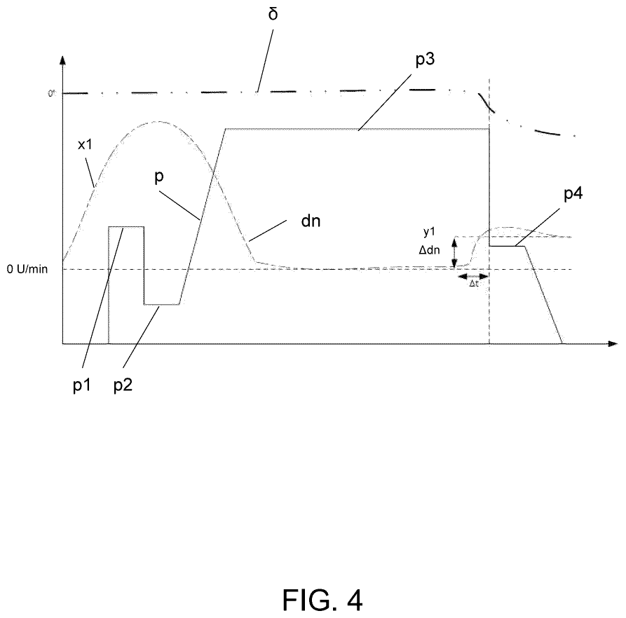

FIG. 4 is a diagram showing the temporal variation of operating parameters of the working machine while the method is being carried out. This diagram relates, as an example, to one of the transverse differentials 31, 32, 33. Once the locking condition when the rotation speed difference dn exceeds the locking threshold value x1 has been met, the locking pressure is first increased to a pre-pressure p1. After a holding time the locking pressure p is reduced to a holding pressure p2. After a further holding time the locking pressure p is increased smoothly along a pressure gradient up to a target pressure p3 in order at least partially to lock the transverse differential 31, 32, 33 smoothly. Due to the at least partial locking of the transverse differential 31, 32, 33 the rotation speed difference dn is reduced bit by bit down to 0 r/min. During the locking of the transverse differential 31, 32, 33 the steering angle δ is equal to 0°.

If the value of the steering angle δ increases, the rotation speed difference dn increases again even though the transverse differential 31, 32, 33 is at least partially locked. A break-free of the transverse differential 31, 32, 33 is recognized and the traction properties are assessed as good if the rotation speed difference dn has exceeded the unlocking threshold value y1 and if the rotation speed difference gradient dn/dt has exceeded the gradient unlocking threshold value. Here, the rotation speed difference gradient dn/dt is determined by way of a change of the rotation speed difference Δdn per time Δt. Thereafter the locking pressure p is reduced to an unlocking holding pressure p4. After an unlocking holding time the locking pressure p is reduced in order to unlock the transverse differential 31, 32, 33. In that way, the transverse differential 31, 32, 33 is unlocked smoothly.

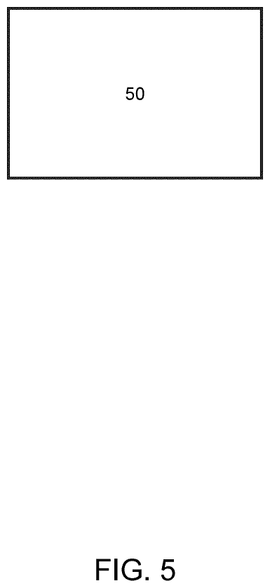

FIG. 5 illustrates the principle of an embodiment of a control unit 50 for carrying out the method. The control unit 50 comprises an input interface and an output interface. The input interface is designed to receive a rotation speed of each of the output elements of the transverse differentials 31, 32, 33, the steering angle δ and the locking pressure p. The output interface is designed to control the differentials.

### INDEXES

11 Motor
12 Traction element
15 Front section
16 Rear section
21 Longitudinal differential
31 Transverse differential, first transverse differential
32 Transverse differential, second transverse differential
33 Transverse differential, third transverse differential
50 Control unit
dn Rotation speed difference
dn/dt Rotation speed difference gradient
x1 Locking threshold value
y1 Unlocking threshold value
p Locking pressure
p1 Pre-pressure
p2 Holding pressure
p3 Target pressure
p4 Unlocking holding pressure
δ Steering angle
I Locking of the transverse differential
II Determination of a rotation speed difference
III Unlocking of the transverse differential
IV Determination of the rotation speed difference gradient

1-11. (canceled)

12. A method for controlling a drive device of a working machine having a motor (11) for delivering a drive power, at least one at least partially lockable transverse differential (31, 32, 33) for dividing the drive power from an input element between two output elements, and a sensor setup for detecting operating parameters, which include the rotation speed of the output elements of the at least one transverse differential (31, 32, 33), such that the operating parameters are appropriate for determining whether a locking condition for the transverse differential (31, 32, 33) has been met, the method comprising:
determining that the locking is met;
at least partially locking the transverse differential (31, 32, 33) based on the locking condition;
determining a rotation speed difference (dn) the output elements of the at least partially locked transverse differential (31, 32, 33);
determining that the rotation speed difference (dn) in an at least partially locked condition of the transverse differential (31, 32, 33) reaches or exceeds an unlocking threshold value (y1), thereby determining that an unlocking condition is met; and
unlocking the transverse differential (31, 32, 33) based on the unlocking condition.

13. The method according to claim 12, wherein the at least partially lockable transverse differential (31, 32, 33) is configured, when the working machine is driving round a curve, to produce the rotation speed difference (dn) of the output elements of the at least partially locked transverse differential (31, 32, 33).

14. The method according to claim 12, wherein determining that the locking condition is met includes determining that the rotation speed difference (dn) reaches or exceeds a locking threshold value (x1).

15. The method according to claim 12, comprising:
determining a rotation speed difference gradient (dn/dt) of the rotation speed difference (dn); wherein
wherein determining that the unlocking condition is met comprises determining that the rotation speed difference gradient (dn/dt) reaches or exceeds a gradient unlocking threshold value.

16. The method according to claim 12, wherein:
the drive device comprises a steering mechanism for steering the working machine;
the sensor setup is configured to detect a steering angle (δ) of the steering mechanism; and
the unlocking threshold value (y1) and/or the gradient unlocking threshold value for small steering angles (δ) is larger than for large steering angles.

17. The method according to claim 12, wherein
the drive device comprises a shifting element for locking the transverse differential (31, 32,33);
the shifting element is designed to be actuated by a locking pressure (p); and
at least partially locking the transverse differential (31, 32, 33) and unlocking the transverse differential (31, 32, 33) comprise adapting the locking pressure (p).

18. The method according to claim 17, wherein at least partially locking the transverse differential (31, 32, 33) comprises adapting the locking pressure (p) to a pre-pressure (p1), then reducing the locking pressure (p) to a holding pressure (p2) and then adapting the locking pressure (p) to a target pressure (p3) in order to lock the transverse differential (31, 32, 33).

19. The method according to claim 17, wherein unlocking the transverse differential (31, 32, 33) comprises reducing the locking pressure (p) to an unlocking holding pressure (p4) and then farther reducing the locking pressure (p) in order to unlock the transverse differential (31, 32. 33).

20. A control unit (50), comprising machine readable code that, when executed, carries out the method according to claim 12.

21. A drive device, comprising:
a motor (11) configured for delivering a drive power;
at least one at least partially lockable transverse differential (31, 32, 33) configured for dividing the drive power from an input element between two output elements;
a sensor setup configured for detecting operating parameters, including a rotation speed of the output elements of the at least one transverse differential (31, 32, 33), such that the operating parameters are appropriate for determining whether a locking condition for the transverse differential (31, 32, 33) has been met; and
a control unit configured to perform the following functions:
determining that the locking is met;
at least partially locking the transverse differential (31, 32, 33) based on the locking condition;
determining a rotation speed difference (dn) the output elements of the at least partially locked transverse differential (31, 32, 33);
determining that the rotation speed difference (dn) in an at least partially locked condition of the transverse differential (31, 32, 33) reaches or exceeds an unlocking threshold value (y1), thereby determining that an unlocking condition is met; and
unlocking the transverse differential (31, 32, 33) based on the unlocking condition.

22. A working machine comprising:
the drive device according to claim 21; and
at least two traction elements (12) which, in order to propel the working machine, are each mechanically functionally connected with one of the output elements of the at least one transverse differential (31, 32, 33).
